(19) United States
(12) Patent Application Publication
(10) Pub. No.: US 2008/0018174 A1
(43) Pub. Date: Jan. 24, 2008

(54) POWER CONTROL APPARATUS AND METHOD THEREOF

(75) Inventor: Kyeong-taeg Yang, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/756,655

(22) Filed: Jun. 1, 2007

(30) Foreign Application Priority Data
Jul. 24, 2006 (KR) 2006-69312

(51) Int. Cl. H02J 1/00; H02J 3/00

(52) U.S. Cl. 307/70

(57) ABSTRACT

A power control apparatus to control power supplied to a load with a predetermined desired voltage level includes a first switch to selectively output a first power to the load, a voltage drop of the first power being less than a predetermined value to meet the desired voltage level, a second switch to selectively output a second power which is different from the first power to the load, a voltage drop of the second power being less than a predetermined value to meet the desired voltage level, and a controller to control the first switch and the second switch to output one of a higher input voltage value from the first power and the second power to the load.

### CROSS-REFERENCE TO RELATED APPLICATIONS

This application claims priority under 35 U.S.C. §119(a) from Korean Patent Application No. 2006-0069312, filed on Jul. 24, 2006, in the Korean Intellectual Property Office, the disclosure of which is incorporated herein in its entirety by reference.

### BACKGROUND OF THE INVENTION

1. Field of the Invention

The present general inventive concept relates to a power control apparatus, and more particularly, to a power control apparatus having a power-efficient and simple circuit to minimize a voltage drop and to select a plurality of powers, and a method thereof.

2. Description of the Related Art

An electronic device, such as mobile printer, includes an adapter to convert external power and a battery provided therein. The electronic device further includes a means, such as a power selection apparatus, a power control apparatus, etc., to select or control power from the adapter (referred to as “adapter power”) and power from the battery (referred to as “battery power”) suitably for conditions.

Referring to FIG. 1, a conventional power selection apparatus 10 is provided. The power selection apparatus 10 includes two diodes 11a and 11b receiving the adapter power (Va) and the battery power (Vb) through respective anodes thereof and providing output power to respective components of the electronic device through cathodes connected together. The power selection apparatus 10 of a diode type has a simple configuration, but has a forward voltage drop due to characteristics of the diode. A forward voltage drop (Vd) may not be considered in an electronic device with relatively small current consumption such as a cellular phone with current consumption of several to tens of mA. In an electronic device such as a mobile printer with current consumption of hundreds of mA and more, however, a forward voltage drop (Vd) is high, and thus voltage of output power (Vout) decreases, thereby not being sufficient for a voltage level as supply power.

Referring to FIG. 2, a power control apparatus 20 is provided as another conventional foregoing means. The power control apparatus 20 includes a switch 21 receiving the adapter power Va and the battery power Vb and outputting one of them to the output power Vout and a microcomputer 22 controlling the switch 21 to output one of the adapter power Va and the battery power Vb according to its conditions. The switch 21 may be realized with a transistor. In this case, a voltage drop due to the switch 21 may not be considered, thereby satisfying a voltage level as a supply power.

However, the forgoing power control apparatus 20 includes the microcomputer 22 to control the switch 21, thereby involving a large-scale and complicated circuit. The microcomputer 22 also is provided with power by an independent circuit, and thus the power control apparatus 20 includes an additional auxiliary power 23. Accordingly, the circuit becomes large and complicated and power loss increases.

### SUMMARY OF THE INVENTION

The present general inventive concept provides a power control apparatus with a small and simple circuit to minimize a voltage drop and to select a plurality of powers.

The present general inventive concept also provides a power control apparatus with small power consumption to minimize a voltage drop and to select a plurality of powers.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept are achieved by providing a power control apparatus to control power supplied to a load with a predetermined desired voltage level, the apparatus comprising a first switch to selectively output a first power to the load, a voltage drop of the first power being less than a predetermined value to meet the desired voltage level, a second switch to selectively output a second power which is different from the first power to the load, a voltage drop of the second power being less than a predetermined value to meet the desired voltage level, and a controller to control the first switch and the second switch to output one of a higher input voltage value from the first power and the second power to the load.

The first switch and the second switch may reduce voltage values of the first power and the second power and output the first power and the second power before being controlled by the controller to output the first power and the second power respectively.

The controller may include a comparator to compare the first power and the second power.

The controller may further include a voltage dividing resistor to distribute at least one of voltages of the first power and the second power.

The first switch and the second switch may each include a MOSFET including a drain to be inputted with the first power or the second power and a source to output the first power or the second power.

The first switch and the second switch may each include a transistor to drive the MOSFET according to control by the controller.

At least one of the first switch and the second switch may further include a protective resistor to connect the source of the MOSFET and the gate thereof.

The foregoing and/or other aspects and utilities of the present general inventive concept may also be achieved by providing a method of controlling power supplied to a load with a predetermined desired voltage level, the method comprising selectively outputting a first power to the load, a voltage drop of the first power being less than a predetermined value to meet the desired voltage level, selectively outputting a second power which is different from the first power to the load, a voltage drop of the second power being less than a predetermined value to meet the desired voltage level, and controlling a first switch and a second switch to output one of a higher input voltage value from the first power and the second power to the load.

The method may further include reducing voltage values of the first power and the second power, and outputting the first power and the second power between controlling the outputting of the first power and the second power respectively.

The foregoing and/or other aspects and utilities of the present general inventive concept may also be achieved by providing a power control apparatus with a controller to control power supplied to a load with a predetermined desired voltage level, the apparatus comprising a first switch to selectively output a first power if the first power is input to the controller, a second switch to selectively output a second power if the second power is input to the controller, and wherein the controller is driven by the output power which is output by the first switch and the second switch.

The controller may control the first switch and the second switch to output one of a higher input voltage.

The foregoing and/or other aspects and utilities of the present general inventive concept may also be achieved by providing a power control apparatus, usable with an electronic apparatus, including a first terminal to receive a first voltage, a second terminal to receive a second voltage, a first switch connected between the first terminal and a load to selectively output the first voltage to the load a second switch connected between the second terminal and the load to selectively output the second voltage to the load, a controller having a comparator to compare the first voltage and the second voltage to generate a control signal to selectively control the first switch and the second switch to turn on and off according to the comparison of the first voltage and the second voltage.

The first switch may include a first MOSFET connected between the first terminal and the load, and a first sub-transistor connected between the comparator and the first MOSFET.

The first sub-transistor may include an NPN transistor having a base connected to the comparator, a collector connected to the first MOSFET, and an emitter connected to ground.

The second switch may include a second MOSFET connected between the second terminal and the load, and a second sub-transistor connected between the comparator and the second MOSFET.

The second sub-transistor may include an NPN transistor having a base connected to the comparator, a collector connected to the second MOSFET, and an emitter connected to ground.

The controller may include a first comparator connected between the first switch and the first and second terminals to receive the first and second voltages, to compare the first and second voltages, and to generate a first control signal to control the first switch.

The first comparator may include positive and negative input terminals connected to the first terminal and the second terminal respectively.

The controller may include a second comparator connected before the second switch and the first and second terminals to receive the first and second voltages to compare the first and second voltages, and to generate a second control signal to control the second switch.

The second comparator may include positive and negative input terminals connected to the second terminal and the first terminal, respectively.

### BRIEF DESCRIPTION OF THE DRAWINGS

These and/or other aspects and utilities of the present general inventive concept will become apparent and more readily appreciated from the following description of the embodiments, taken in conjunction with the accompany drawings of which:

FIG. 1 is a circuit diagram to illustrate a conventional power selection apparatus;

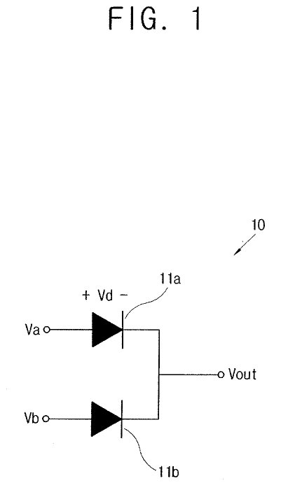

FIG. 2 is a circuit diagram to illustrate a conventional power control apparatus; and

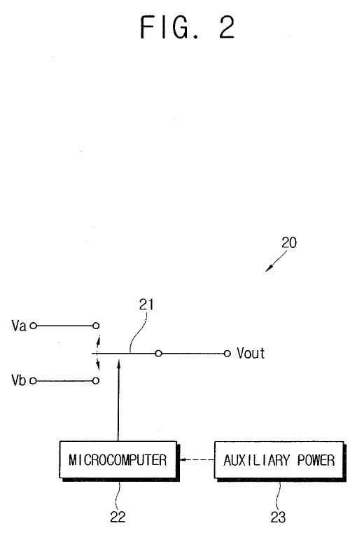

FIG. 3 is a circuit diagram to illustrate configuration of a power control apparatus according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

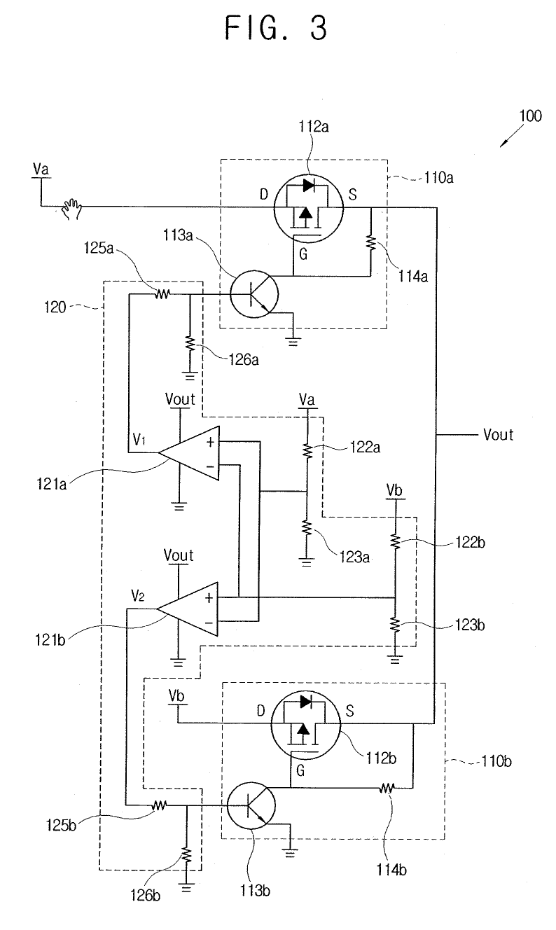

FIG. 3 is a circuit diagram to illustrate a configuration of a power control apparatus 100 according to an exemplary embodiment of the present general inventive concept. The power control apparatus 100 provides power (referred to as “output power”) to an electronic device (not illustrated), such as a mobile printer, to operate. The electronic device according to an embodiment of the present general inventive concept includes an adapter to convert external power and a battery provided therein. The power control apparatus 100 may be provided in the electronic device or may be detachable from the electronic device. A voltage level of the power provided to the electronic device may exceed a predetermined value (referred to as “desired voltage level”) to operate the electronic device. In an embodiment of the present general inventive concept, the electronic device is described with a load.

The power control apparatus 100 selectively outputs one of adapter power Va and battery power Vb as output power depending on conditions corresponding to the power control apparatus 100, to minimize a voltage drop of the powers. The power control apparatus 100 includes a first switch 110a, a second switch 110b and a controller 120.

The first switch 110a selectively outputs the adapter power Va as output power Vout under control of the controller 120 if the adapter power Va is input. The second switch 110b selectively outputs the battery power Vb as output power Vout under the control of the controller 120 if the battery power Vb is input. In the present embodiment, a first power and a second power are described with respect to the adapter power Va and the battery power Vb, respectively.

The first switch 110a and the second switch 110b comprise a first metal-oxide semiconductor field effect transistor (“MOSFET”) 112a and a second MOSFET 112b, respectively. A voltage drop may not be considered in the MOSFETs although a high electric current flows in a turn-on state due to their characteristics, and thus a magnitude of the voltage drop becomes less than a predetermined value to meet the desired voltage level of the electronic device. Thus, the voltage drop of the adapter power Va or the battery power Vb can be minimized. The first MOSFET 112a and the second MOSFET 112b may be of p-type.

The controller 120 controls the first switch 110a and the second switch 110b to output one of a higher input voltage from the adapter power Va and the battery power Vb. That is, if one of the adapter power Va and the battery power Vb is input, the controller 120 outputs the input power. If both of the adapter power Va and the battery power Vb are input, the controller 120 outputs one with a higher voltage value. In the exemplary embodiment, the adapter power Va is provided with a voltage value of about 5V, and the battery power Vb is provided with a voltage value of about 4.2V. If both of the adapter power Va and the battery power Vb are input, the adapter power Va is output, thereby minimizing battery consumption.

The controller 120 comprises a first comparator 121a to output a first control signal V1 corresponding to voltage levels of the adapter power Va and the battery power Vb and a second comparator 121b to output a second control signal V2 with an opposite logic condition to the first control signal V1. The first comparator 121a and the second comparator 121b may be provided by an operational amplifier (OP-Amp), as an example, which has a simple circuit and consumes less power to minimize power consumption.

The first comparator 121a outputs the first control signal V1 which has a high logic state when the voltage value of the adapter power Va is higher than the battery power Vb and a low logic state when the voltage value of the adapter power Va is lower than the battery power Vb. In contrast, the second comparator 121b outputs the second control signal V2 which has a high logic state when the voltage value of the battery power Vb is higher than the adapter power Va, and a low logic condition when the voltage value of the battery power Vb is lower than the adapter power Va. Accordingly, the first control signal V1 and the second control signal V2 have opposite logic conditions.

The controller 120 may further comprise first voltage dividing resistors 122a and 123a and second voltage dividing resistors 122b and 123b to divide voltages of the adapter power Va and the battery power Vb to be inputted to the first comparator 121a and the second comparator 121b, respectively. The first voltage dividing resistors 122a and 123a and the second voltage dividing resistors 122b and 123b may have an equal resistance value. Alternatively, resistance values of the first voltage dividing resistors 122a and 123a and the second voltage dividing resistors 122b and 123b may be adjusted properly, thereby preventing the battery power Vb from being undesirably selected if the battery power Vb is erroneously recognized as being larger than the adapter power Va. Thus, it is preferred that the resistance value of the first voltage dividing resistor 123a sets high or the resistance value of the second voltage dividing resistor 123b sets low.

The controller 120 is driven by the output power which is output by the first switch 110a and the second switch 110b (referred to 121a and 121b). Thus, auxiliary power is not necessary to drive the controller 120, resulting in a small and simple circuit.

To being driving the controller 120 which is not connected to any power sources (e.g., the adapter or the battery), the controller 120 should be initially provided with driving power by connecting either the adapter (e.g., external power source) or the battery. Accordingly, the first switch 110a and the second switch 110b reduce the voltage value of the adapter power Va or the battery power Vb by a certain value and output one of either the adapter power Va or the battery power Vb as output power Vout before being controlled by the controller 120 to output the adapter power Va or the battery power Vb.

The first MOSFET 112a of the first switch 110a and the second MOSFET 112b of the second switch 110b each comprise a drain D to be input with the adapter power Va or the battery power Vb, and a source to output the output power Vout. Accordingly, since the drain and the source operate as a forward diode when the first MOSFET 112a and the second MOSFET 112b are turned off, the adapter power Va or the battery power Vb is dropped in voltage and is output as output power Vout. Herein, the voltage value of the output power Vout does not come up to one of the adapter power Va or the battery power Vb, but is enough to operate the first comparator 121a and the second comparator 121b. The voltage values to operate the first comparator 121a and the second comparator 121b may be in a range of 2V to 18V.

The first switch 110a and the second switch 110b may further comprise a first transistor 113a and a second transistor 113b to operate the first MOSFET 112a and the second MOSFET 112b under the control by the controller 120, respectively. The first transistor 113a and the second transistor 113b may be provided as npn-type bipolar transistors. The controller 120 may further comprise third voltage dividing resistors 125a and 126a and fourth voltage dividing resistors 125b and 126b to distribute ample voltages corresponding to the first control signal V1 and the second control signal V2 corresponding to base currents of the first transistor 113a and the second transistor 113b respectively.

The first switch 110a and the second switch 110b may further comprise protective resistors 114a and 114b to connect the sources S of the first MOSFET 112a and the second MOSFET 112b and gates G thereof, to prevent malfunction of the first MOSFET 112a and the second MOSFET 112b due to noise, respectively.

Hereinafter, operation of the power control apparatus 100 will be described in detail. If the adapter power Va is input and the battery power Vb is not input, the voltage value of the adapter power Va is higher than that of the battery value Vb. Thus, the first comparator 121a outputs the first control signal V1 corresponding to a high logic state, and the second comparator 121b outputs the second control signal V2 corresponding to a low logic state.

The first transistor 113a is turned on by the first control signal V1 corresponding to the high logic state, so that the gate G of first MOSFET 112a is grounded. As described above, the source S of the first MOSFET 112a remains in the state that the voltage-dropped adapter power Va is input. Accordingly, a voltage difference between the gate G of the first MOSFET 112a and the source S thereof meets a turn-on condition of the MOSFETs, that is a voltage difference of 1V to 3V between the gate G and the source S, respectively, thereby turning on the first MOSFET 112a. Accordingly, the voltage level of the output power Vout is almost equal to that of the adapter power Va.

Meanwhile, the second transistor 113b is turned off by the second control signal V2 corresponding to the low logic state. Accordingly, a voltage difference between the gate G of the second MOSFET 112b and the source S thereof does not meet the turn-on condition of the MOSFETs, thereby turning off the second MOSFET 112b.

In contrast, if the adapter power Va is not input and the battery power Vb is input, the voltage level of the output power Vout is almost equal to that of the battery power Vb.

If both the adapter power Va and the battery power Vb are input, the voltage value of the adapter power Va is higher than the battery power Vb, and thus the voltage level of the output power Vout is almost equal to that of the adapter power Va, as when the adapter power Va is input and the battery power Vb is not.

As described above, the present general inventive concept provides a power control apparatus with a small and simple circuit to minimize a voltage drop and to select a plurality of powers.

Further, the present general inventive concept provides a power control apparatus with small power consumption to minimize a voltage drop and to select a plurality of powers.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A power control apparatus to control power supplied to a load with a predetermined desired voltage level, the apparatus comprising:
a first switch to selectively output a first power to the load, a voltage drop of the first power being less than a predetermined value to meet the desired voltage level;
a second switch to selectively output a second power which is different from the first power to the load, a voltage drop of the second power being less than a predetermined value to meet the desired voltage level; and
a controller to control the first switch and the second switch to output one of a higher input voltage value from the first power and the second power to the load.

2. The power control apparatus according to claim 1, wherein the first switch and the second switch reduce voltage values of the first power and the second power and output the first power and the second power before being controlled by the controller to output the first power and the second power respectively.

3. The power control apparatus according to claim 1, wherein the controller comprises:
a comparator to compare the first power and the second power.

4. The power control apparatus according to claim 1, wherein the controller further comprises:
a voltage dividing resistor to distribute at least one of voltages of the first power and the second power.

5. The power control apparatus according to claim 1, wherein the first switch and the second switch each comprise:
a MOSFET including a drain to be inputted with the first power or the second power; and
a source to output the first power or the second power.

6. The power control apparatus according to claim 5, wherein the first switch and the second switch each comprise:
a transistor to drive the MOSFET according to control by the controller.

7. The power control apparatus according to claim 5, wherein at least one of the first switch and the second switch further comprises:
a protective resistor to connect the source of the MOSFET and the gate thereof.

8. A method of controlling power supplied to a load with a predetermined desired voltage level, the method comprising:
selectively outputting a first power to the load, a voltage drop of the first power being less than a predetermined value to meet the desired voltage level;
selectively outputting a second power which is different from the first power to the load, a voltage drop of the second power being less than a predetermined value to meet the desired voltage level; and
controlling a first switch and a second switch to output one of a higher input voltage value from the first power and the second power to the load.

9. The method of claim 8, further comprising:
reducing voltage values of the first power and the second power; and
outputting the first power and the second power between controlling the outputting of the first power and the second power respectively.

10. A power control apparatus with a controller to control power supplied to a load with a predetermined desired voltage level, the apparatus comprising:
a first switch to selectively output a first power if the first power is input to the controller;
a second switch to selectively output a second power if the second power is input to the controller; and
wherein the controller is driven by the output power which is output by the first switch and the second switch.

11. The power control apparatus of claim 10, wherein the controller controls the first switch and the second switch to output one of a higher input voltage.

12. A power control apparatus, usable with an electronic apparatus, comprising: a first terminal to receive a first voltage;
a second terminal to receive a second voltage;
a first switch connected between the first terminal and a load to selectively output the first voltage to the load;
a second switch connected between the second terminal and the load to selectively output the second voltage to the load;
a controller having a comparator to compare the first voltage and the second voltage to generate a control signal to selectively control the first switch and the second switch to turn on and off according to the comparison of the first voltage and the second voltage.

13. The apparatus of claim 12, wherein the first switch comprises a first MOSFET connected between the first terminal and the load, and a first sub-transistor connected between the comparator and the first MOSFET.

14. The apparatus of claim 13, wherein the first sub-transistor comprises an NPN transistor having a base connected to the comparator, a collector connected to the first MOSFET, and an emitter connected to ground.

15. The apparatus of claim 13, wherein the second switch comprises a second MOSFET connected between the second terminal and the load, and a second sub-transistor connected between the comparator and the second MOSFET.

16. The apparatus of claim 15, wherein the second sub-transistor comprises an NPN transistor having a base connected to the comparator, a collector connected to the second MOSFET, and an emitter connected to ground.

17. The apparatus of claim 12, wherein the controller comprises a first comparator connected between the first switch and the first and second terminals to receive the first and second voltages, to compare the first and second voltages, and to generate a first control signal to control the first switch.

18. The apparatus of claim 17, wherein the first comparator comprises positive and negative input terminals connected to the first terminal and the second terminal respectively.

19. The apparatus of claim 17, wherein the controller comprises a second comparator connected before the second switch and the first and second terminals to receive the first and second voltages to compare the first and second voltages, and to generate a second control signal to control the second switch.

20. The apparatus of claim 19, wherein the second comparator comprises positive and negative input terminals connected to the second terminal and the first terminal, respectively.
